(19) United States
(12) Patent Application Publication
(10) Pub. No.: US 2018/0275792 A1
(43) Pub. Date: Sep. 27, 2018

(54) Three-dimensional Touch Screen and Touch Foil Structure

(71) Applicant: WUHU LUNFENG ELECTRONIC TECHNOLOGY CO., LTD., Wuhu, Anhui (CN)

(72) Inventor: Chuan Hu, Yiwu, Zhejiang (CN)

(21) Appl. No.: 15/763,835

(22) PCT Filed: Dec. 25, 2015
(86) PCT No.: PCT/CN2015/098993

§ 371 Date: Mar. 27, 2018

(51) Int. Cl. G06F 3/044; G06F 3/041; G06F 1/16

(52) U.S. Cl. CPC G06F 3/044; G06F 3/0412; G06F 2203/04104; G06F 1/1656; G06F 1/1643; G06F 3/0414

(57) ABSTRACT

A three-dimensional touch screen and a touch foil structure are provided, wherein the three-dimensional touch screen comprises a display screen; a touch foil structure adhered to an upper surface of the display screen; and a glass cover plate covering an upper surface of the touch foil structure; wherein the touch foil structure comprises a first conductive layer, a second conductive layer and a third conductive layer in sequence from bottom to top, and an insulating particulate layer is arranged between the first conductive layer and the second conductive layer. The three-dimensional touch screen of the present invention has a reduced thickness and a higher sensitivity and thus a better user experience. The present invention is fully compatible with multi-touch two-dimensional capacitive screen. It realizes three-dimensional touch and uses a hard cover at the same time, which can further improve reliability and user experience.

### FIELD OF THE INVENTION

The present invention relates to the technical field of three-dimensional touch screen, particularly to a three-dimensional touch screen and a touch foil structure.

### BACKGROUND OF THE INVENTION

A touch screen is a kind of inductive liquid crystal display device which can receive the input signal of a contact. When touching the graphic buttons on the screen, the haptic feedback system on the screen can drive all kinds of connecting devices according to preprogrammed programs. The touch screen can replace the conventional mechanical button panel, and create vivid audio and video effects through LCD screen.

Existing touch screens are classified into two-dimensional touch screens and three-dimensional touch screens. Existing three-dimensional touch screens are resistance touch screens or capacitance touch screens, which add a sensor behind the display screen. In principle, this method avoids light transmission requirements of the third dimension material. However, since the sensor is located further away from the user's finger, the sensor is required to have a higher sensitivity.

### SUMMARY OF THE INVENTION

The present invention has been made in view of the above circumstances, and the object of the present invention is to provide a three-dimensional touch screen which is simple to manufacture and has high touch sensitivity.

To achieve the object, the present invention adopts the following technical solutions.

The present invention provides a three-dimensional touch screen comprising:

a display screen;

a touch foil structure adhered to an upper surface of the display screen; and

a glass cover plate covering an upper surface of the touch foil structure;

wherein the touch foil structure comprises a first conductive layer, a second conductive layer and a third conductive layer in sequence from bottom to top, and an insulating particulate layer is arranged between the first conductive layer and the second conductive layer;

wherein whether there is a pressure signal or not is determined by measuring a change in capacitance or a short circuit between the first conductive layer and the second conductive layer, and a location where the touch signal is generated is determined by scanning capacitance between the second and third conductive layers and a surrounding.

Further, the three-dimensional touch screen further comprises a first substrate and a second substrate, wherein the first conductive layer is disposed on an upper surface of the first substrate, the second conductive layer is disposed on an lower surface of the second substrate, and the third conductive layer is disposed on an upper surface of the second substrate.

Further, the three-dimensional touch screen further comprises a first substrate, a second substrate and a third substrate, wherein the first conductive layer is disposed on an upper surface of the first substrate, the second conductive layer is disposed on an upper surface of the second substrate, and the third conductive layer is disposed on an upper surface of the third substrate.

Further, the three-dimensional touch screen further comprises a first substrate, a second substrate and a third substrate, wherein the first conductive layer is disposed on an upper surface of the first substrate, the second conductive layer is disposed on a lower surface of the second substrate, and the third conductive layer is disposed on an upper surface of the third substrate.

Further, a conductive pattern of the first conductive layer and a conductive pattern of the second conductive layer each is in the form of a plurality of bar-shaped blocks arranged in parallel, and the conductive pattern of the first conductive layer is parallel or perpendicular to the conductive pattern of the second conductive layer.

Further, a conductive pattern of the first conductive layer is in the form of a plurality of bar-shaped blocks arranged in parallel, and a conductive pattern of the second conductive layer is in the form of a plurality of independent conductive blocks.

Further, the insulating particle layer comprises a plurality of insulating particles, each of the insulating particles has a thickness of 5 to 50 μm, and a distance between adjacent insulating particles is 2 to 7 mm.

Optionally, the insulating particles have a thickness of 15 to 25 μm.

Optionally, the conductive patterns of the first conductive layer and the second conductive layer are made of ITO(Indium tin oxide) or nano-silver material.

Optionally, the display screen and the touch foil structure as well as the touch foil structure and the glass cover plate are bonded by an OCA(Optically Clear Adhesive) Adhesive.

Optionally, the substrates are made of PET(Polyethylene terephthalate) material.

Optionally, when the pressure exerted by a user on the three-dimensional touch screen is greater than or equal to 300 g, the first conductive layer and the second conductive layer come into contact with each other and are short-circuited, and when the pressure exerted by a user on the three-dimensional touch screen is in the range of 50 to 300 g, the capacitance values of the first conductive layer and the second conductive layer change.

The present invention further provides a touch foil structure comprising a first conductive layer, a second conductive layer and a third conductive layer in sequence from bottom to top, wherein insulating particles are disposed between the first conductive layer and the second conductive layer, wherein a conductive pattern of the first conductive layer is parallel or perpendicular to a conductive pattern of the second conductive layer, and wherein whether there is a pressure signal or not is determined by measuring a change in capacitance or a short circuit between the first conductive layer and the second conductive layer, and a location where the touch signal is generated is determined by scanning capacitance between the second and third conductive layers and a surrounding.

Further, the three-dimensional touch screen further comprises a first substrate and a second substrate, wherein the first conductive layer is disposed on an upper surface of the first substrate, the second conductive layer is disposed on an lower surface of the second substrate, and the third conductive layer is disposed on an upper surface of the second substrate.

Optionally, the three-dimensional touch screen further comprises a first substrate, a second substrate and a third substrate, wherein the first conductive layer is disposed on an upper surface of the first substrate, the second conductive layer is disposed on an upper surface of the second substrate, and the third conductive layer is disposed on an upper surface of the third substrate.

Optionally, the three-dimensional touch screen further comprises a first substrate, a second substrate and a third substrate, wherein the first conductive layer is disposed on an upper surface of the first substrate, the second conductive layer is disposed on a lower surface of the second substrate, and the third conductive layer is disposed on an upper surface of the third substrate.

Optionally, a conductive pattern of the first conductive layer and a conductive pattern of the second conductive layer each is in the form of a plurality of bar-shaped blocks arranged in parallel.

Preferably, a conductive pattern of the first conductive layer is in the form of a plurality of bar-shaped blocks arranged in parallel, and a conductive pattern of the second conductive layer is in the form of a plurality of independent conductive blocks.

The three-dimensional touch screen of the present invention has a reduced thickness and a higher sensitivity and thus a better user experience. The present invention is fully compatible with multi-touch two-dimensional capacitive screen. It realizes three-dimensional touch function and uses a hard cover plate to cover the touch structure at the same time, which can further improve reliability and user experience. With the three-dimensional touch screen manufacturing process of the present invention, manufacturing process and requirements for IC driving are simplified, and thus production cost is greatly reduced.

### BRIEF DESCRIPTION OF THE DRAWINGS

FIG. 1 is a structure of a first embodiment of the three-dimensional touch screen of the present invention;

FIG. 2 is a structure of a second embodiment of the three-dimensional touch screen of the present invention;

FIG. 3 is a structure of a third embodiment of the three-dimensional touch screen of the present invention;

FIG. 4 is a structure of a fourth embodiment of the three-dimensional touch screen of the present invention;

FIG. 5 is an embodiment of the conductive layer pattern of the three-dimensional touch screen of the present invention;

FIG. 6 is another embodiment of the conductive layer pattern of the three-dimensional touch screen of the present invention.

### DETAILED DESCRIPTION OF ILLUSTRATED EMBODIMENTS

Preferred embodiments of the three-dimensional touch screen of the present invention are described in detail below with reference to the accompanying drawings. However, the present invention is not limited to these embodiments.

### Embodiment One

As shown in FIG. 1, a three-dimensional touch screen of the present invention includes:

a display screen;

a touch foil structure adhered to an upper surface of the display screen; and

a glass cover plate covering an upper surface of the touch foil structure;

wherein the touch foil structure comprises a first conductive layer, a second conductive layer and a third conductive layer in sequence from bottom to top, and an insulating particulate layer is arranged between the first conductive layer and the second conductive layer; wherein whether there is a pressure signal or not is determined by measuring a change in capacitance or a short circuit between the first conductive layer and the second conductive layer, and a location where the touch signal is generated is determined by scanning capacitance between the second and third conductive layers and a surrounding. Note that in the present invention, a lower side refers to the side close to the display screen and an upper side refers to the side away from the display screen. The capacitance between the conductive layers and the surrounding mainly refers to the capacitance formed between the conductive layers and the user's finger. When the user touches the three-dimensional touch screen, the user's finger and the conductive layer work surface form a coupling capacitor.

It should be noted that generation of a pressure signal is caused by pressing operation, and a pressure signal is generated when the user presses the three-dimensional touch screen. A touch signal can be triggered by a normal touching operation. Detection of pressure signal is separated from detection of touch signal. Pressing operation causes both a pressure signal and a touch signal to generate. When performing touching operation with no pressing operation, only a touch signal is to be generated.

Specifically, when the touch pressure is greater than or equal to 300 g, contact of the first conductive layer and the second conductive layer causes short circuit of the conductive channel, and a pressure signal and a touch signal are generated. When the touch pressure is within a range of 50 to 300 g, the first conductive layer and the second conductive layer are not in contact with each other, but the capacitance values of the first conductive layer and the second conductive layer change due to deformation, and thus a touch signal and a pressure signal are also generated at this time. When the touch pressure is less than 50 g, the capacitance value changes less, and thus a pressure signal is not triggered but only a touch signal is generated.

The insulating particles may be printed on the first conductive layer and have a thickness of 5 to 50 μm. The insulating particles may have a diameter of 20 to 100 μm, and the distance between adjacent insulating particles may be 2 to 7 mm. When the thickness of the insulating particles and the distance between them are within the said ranges, generation of the pressure signal and the touch signal can be more accurate. As described above, a controller can accurately control the touch pressure range according to the settings of the insulating particles, thereby precisely determining at what intensity the user is performing a pressing operation and at what intensity the user is performing a touching operation.

The conductive pattern on the conductive layer may be made of ITO or nano silver material. The display screen and the touch foil structure as well as the touch foil structure and the glass cover plate are bonded by OCA(Optically Clear Adhesive) glue. ITO is indium tin oxide, with high transmittance and great conductivity. OCA Glue is a special adhesive used to bond transparent optical components.

In this embodiment, as shown in FIG. 1, the three-dimensional touch screen further includes a first substrate and a second substrate. The first conductive layer is disposed on an upper surface of the first substrate, and the second conductive layer and the third conductive layer are respectively disposed on a lower surface and an upper surface of the second substrate. The substrates are made of PET(Polyethylene terephthalate) material. PET's chemical name is polyethylene terephthalate, which is a high polymer.

The touch foil structure in embodiment one can be made by the following method:

step A, preparing a first conductive substrate: coating an ITO conductive layer on the pattern area of the upper surface of the first substrate, coating a conductive silver paste at the bezel, forming a first ITO conductive layer by laser engraving (or photolithography), and printing spacer particles on the first ITO conductive layer;

step B, making a second conductive substrate: using the above method, forming a third ITO conductive layer and a second ITO conductive layer respectively on the upper and lower surfaces of the second substrate by screen printing or photolithography, the conductive pattern of the third ITO conductive layer being perpendicular to the conductive pattern of second ITO conductive layer;

step C, combining the first conductive substrate and the second conductive substrate so that the first ITO conductive layer is opposite to the second conductive layer.

When the user touches the three-dimensional touch screen, the user's finger forms a coupling capacitance with the working surface of the three-dimensional touch screen (such as the conductive layer of the ITO coating), so that the finger sucks a small current from the contact point. The controller can accurately determine the location of the touch by scanning the first and second dimensions (eg, x-direction and y-direction) of the second and third two-layer electrical conductors, by measuring capacitance change, the controller can determine the size of the pressure in the third dimension (z direction).

### Embodiment Two

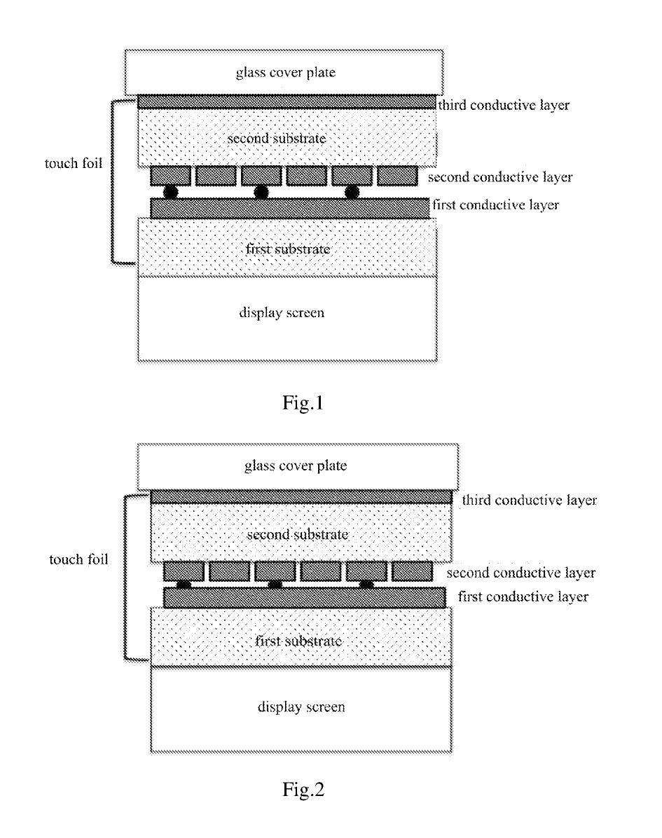

FIG. 2 shows the structure of a second three-dimensional touch screen according to the present invention. The structure of this three-dimensional touch screen is similar to that of the first embodiment except that the thickness of the spacer particles is different. In this embodiment, the spacer particles have a thickness of about 15 to 25 μm.

With this spacer particles having a thin thickness, when the user touches the three-dimensional touch screen, positions in the X and Y axis directions can be measured for accurate positioning by using the capacitive sensing method. When the user's touch pressure is relatively large, the first conductive layer comes into contact with the second conductive layer, and positions in the X and Y axis directions are measured for accurate positioning by measuring a change of resistance.

### Embodiment Three

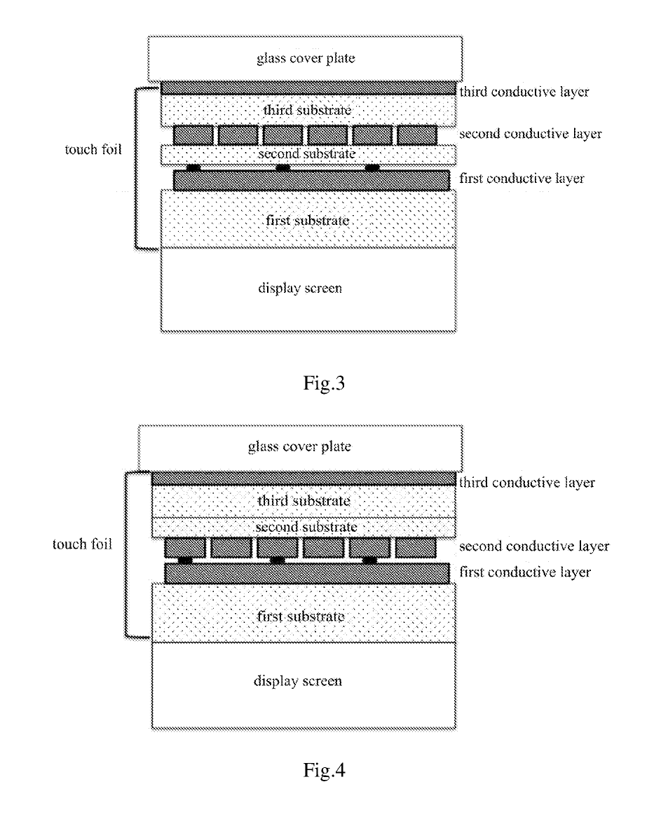

FIG. 3 shows a structure of a third three-dimensional touch screen of the present invention comprising:

a display screen;

a touch foil structure adhered to an upper surface of the display screen;

a glass cover plate covering an upper surface of the touch foil structure;

the touch foil structure comprises a first conductive layer, a second conductive layer and a third conductive layer in sequence from bottom to top, and insulating particles are disposed between the first conductive layer and the second conductive layer; the conductive pattern of the layer is perpendicular to the conductive pattern of the second conductive layer. The three-dimensional touch screen further includes a first substrate, a second substrate, and a third substrate. The first conductive layer is disposed on an upper surface of the first substrate, the second conductive layer is disposed on an upper surface of the second substrate, and the third conductive layer is disposed on an upper surface of the third substrate.

The insulating particles may be printed on the first conductive layer and have a thickness of 10 to 50 μm. The conductive patterns on the conductive layers may be made of ITO or nano silver material. The display screen and the touch foil structure as well as the touch foil structure and the glass cover plate are adhered by OCA glue. The substrates are made of PET material.

The touch foil structure in embodiment three can be made by the following method:

step A, making a first conductive substrate: forming a nano-silver conductive pattern on a pattern area of an upper surface of a first substrate, forming a conductive silver paste frame border around at bezel area to form a first conductive layer, and printing spacer particles on the first conductive layer;

step B, making a second conductive substrate: forming a second conductive layer on a lower surface of a second substrate by the same method as described above;

step C, making a third conductive substrate: forming a third conductive layer on an upper surface of a third substrate;

step D, finishing the touch foil structure: bonding the first conductive substrate, the third conductive substrate and the second conductive substrate in sequence from bottom to top.

### Embodiment Four

FIG. 4 shows a structure of a fourth touch foil structure of the present invention, which is different from the third touch foil structure in that the conductive layer of the third conductive substrate is located on the lower surface of the third substrate.

“Conductive Layer Pattern”

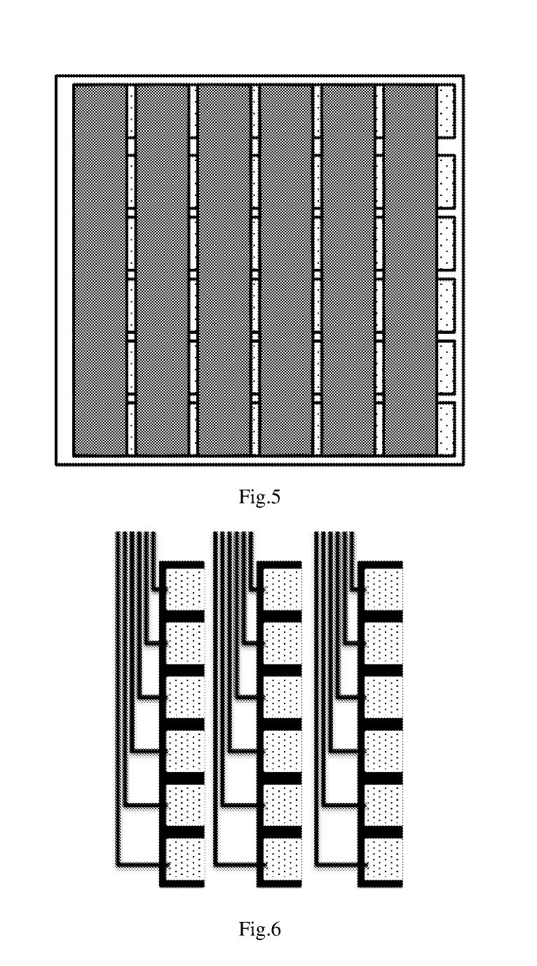

In the present invention, patterns of the conductive layers can be implemented in various ways. As shown in FIG. 5, the pattern of the first conductive layer and the pattern of the second conductive layer each is in the form of a plurality of bar-shaped blocks arranged in parallel, and the two patterns are perpendicular to each other. Measurements of change of touch pressure and location of touch can be performed by comparing the mutual capacitance value of the two layers in the situation of performing pressing operation with the mutual capacitance value of the two layers in the situation of not performing pressing operation.

Specifically, the following method can be used: firstly, measuring an n^{th} channel of the second conductive layer, scanning all the channels of the first layer and measuring the mutual capacitance values between the n^{th} channel of the second conductive layer and all the channels of the first layer; secondly, measuring an (n+1)^{th} channel of the second conductive layer, scanning all the channels of the first conductive layer and measuring the mutual capacitance values between the (n+1)^{th} channel of the second conductive layer and all the channels of the first conductive layer; wherein measurement is performed a total times of N (total number of channels of the first layer)×M (total number of channels of second layer), and then judgment is made regarding whether there is a touch as well as a touch depth in case there is a touch.

In addition, as shown in FIG. 6, the pattern of the second conductive layer may be in the form of a plurality of bar-shaped blocks arranged in parallel, while the pattern of the first conductive layer is in the form of a plurality of independent conductive blocks. A plurality of wires is disposed on the conductive layer, and each of the conductive blocks is connected to the frame winding and the driving IC by wires to determine magnitude of pressure. The specific measurement method is similar to that of FIG. 5, for example, the measurement includes selecting one channel of the second conductive layer, scanning the capacitance (and short circuit condition) of all the small blocks of a first layer in this channel, and then switching to a next channel of the second conductive layer and repeating scanning of the small blocks. The pressure situation is assessed until all the measurements are completed.

The three-dimensional touch screen of the present invention has a reduced thickness and a higher light transmittance, thereby having a higher sensitivity and thus better user experience. The three-dimensional touch screen manufacturing process of the present invention simplifies manufacturing process and greatly reduces production cost.

The contents described in the embodiments of the present specification are merely examples of the implementations of the inventive concept, and the protection scope of the present invention should not be considered as being limited to the specific forms as set forth in the embodiments. The protection scope of the present invention also encompasses equivalent technical means that can be conceived by one skilled in the art according to the inventive concept.

1. A three-dimensional touch screen, characterized in that the three-dimensional touch screen comprises:
a display screen;
a touch foil structure adhered to an upper surface of the display screen; and
a glass cover plate covering an upper surface of the touch foil structure;
wherein the touch foil structure comprises a first conductive layer, a second conductive layer and a third conductive layer in sequence from bottom to top, and an insulating particulate layer is arranged between the first conductive layer and the second conductive layer;
wherein whether there is a pressure signal or not is determined by measuring a change in capacitance or a short circuit between the first conductive layer and the second conductive layer, and a location where the touch signal is generated is determined by scanning capacitance between the second and third conductive layers and a surrounding.

2. The three-dimensional touch screen according to claim 1, characterized in that the three-dimensional touch screen further comprises a first substrate and a second substrate, wherein the first conductive layer is disposed on an upper surface of the first substrate, the second conductive layer is disposed on a lower surface of the second substrate, and the third conductive layer is disposed on an upper surface of the second substrate.

3. The three-dimensional touch screen of claim 1, characterized in that the three-dimensional touch screen further comprises a first substrate, a second substrate and a third substrate, wherein the first conductive layer is disposed on an upper surface of the first substrate, the second conductive layer is disposed on an upper surface of the second substrate, and the third conductive layer is disposed on an upper surface of the third substrate.

4. The three-dimensional touch screen according to claim 1, characterized in that the three-dimensional touch screen further comprises a first substrate, a second substrate and a third substrate, wherein the first conductive layer is disposed on an upper surface of the first substrate, the second conductive layer is disposed on a lower surface of the second substrate, and the third conductive layer is disposed on an upper surface of the third substrate.

5. The three-dimensional touch screen according to claim 1, characterized in that a conductive pattern of the first conductive layer and a conductive pattern of the second conductive layer each is in the form of a plurality of bar-shaped blocks arranged in parallel, and the conductive pattern of the first conductive layer is parallel or perpendicular to the conductive pattern of the second conductive layer.

6. The three-dimensional touch screen according to claim 1, characterized in that a conductive pattern of the first conductive layer is in the form of a plurality of bar-shaped blocks arranged in parallel, and a conductive pattern of the second conductive layer is in the form of a plurality of independent conductive blocks.

7. The three-dimensional touch screen according to claim 1, characterized in that the insulating particle layer comprises a plurality of insulating particles, wherein each of the insulating particles has a thickness of 5 to 50 μm, and a distance between adjacent insulating particles is 2 to 7 mm.

8. The three-dimensional touch screen of claim 7, characterized in that the insulating particles have a thickness of 15 to 25 μm.

9. The three-dimensional touch screen according to claim 1, characterized in that the conductive patterns of the first conductive layer and the second conductive layer are made of ITO or nano-silver material.

10. The three-dimensional touch screen according to claim 1, characterized in that the display screen and the touch foil structure as well as the touch foil structure and the glass cover plate are bonded by an OCA Adhesive.

11. The three-dimensional touch screen according to claim 2, characterized in that the so called substrates are made of PET material.

12. The three-dimensional touch screen according to claim 1, characterized in that when the pressure exerted by a user on the three-dimensional touch screen is greater than or equal to 300 g, the first conductive layer and the second conductive layer come into contact with each other and are short-circuited, and when the pressure exerted by a user on the three-dimensional touch screen is in the range of 50 to 300 g, the capacitance values of the first conductive layer and the second conductive layer change.

13. A touch foil structure, characterized in that the touch foil structure comprises a first conductive layer, a second conductive layer and a third conductive layer in sequence from bottom to top, wherein insulating particles are disposed between the first conductive layer and the second conductive layer, wherein a conductive pattern of the first conductive layer is parallel or perpendicular to a conductive pattern of the second conductive layer, and wherein whether there is a pressure signal or not is determined by measuring a change in capacitance or a short circuit between the first conductive layer and the second conductive layer, and a location where the touch signal is generated is determined by scanning capacitance between the second and third conductive layers and a surrounding.

14. The touch foil structure as claimed in claim 13, characterized in that the three-dimensional touch screen further comprises a first substrate and a second substrate, wherein the first conductive layer is disposed on an upper surface of the first substrate, the second conductive layer is disposed on a lower surface of the second substrate, and the third conductive layer is disposed on an upper surface of the second substrate.

15. The touch foil structure as claimed in claim 13, characterized in that the three-dimensional touch screen further comprises a first substrate, a second substrate and a third substrate, wherein the first conductive layer is disposed on an upper surface of the first substrate, the second conductive layer is disposed on an upper surface of the second substrate, and the third conductive layer is disposed on an upper surface of the third substrate.

16. The touch foil structure as claimed in claim 13, characterized in that the three-dimensional touch screen further comprises a first substrate, a second substrate and a third substrate, wherein the first conductive layer is disposed on an upper surface of the first substrate, the second conductive layer is disposed on a lower surface of the second substrate, and the third conductive layer is disposed on an upper surface of the third substrate.

17. The touch foil structure according to claim 13, characterized in that a conductive pattern of the first conductive layer and a conductive pattern of the second conductive layer each is in the form of a plurality of bar-shaped blocks arranged in parallel.

18. The touch foil structure according to claim 13, characterized in that a conductive pattern of the first conductive layer is in the form of a plurality of bar-shaped blocks arranged in parallel, and a conductive pattern of the second conductive layer is in the form of a plurality of independent conductive blocks.

19. The touch foil structure according to claim 14, characterized in that a conductive pattern of the first conductive layer is in the form of a plurality of bar-shaped blocks arranged in parallel, and a conductive pattern of the second conductive layer is in the form of a plurality of independent conductive blocks.

20. The touch foil structure according to claim 15, characterized in that a conductive pattern of the first conductive layer is in the form of a plurality of bar-shaped blocks arranged in parallel, and a conductive pattern of the second conductive layer is in the form of a plurality of independent conductive blocks.
